(19) United States
(12) Patent Application Publication
(10) Pub. No.: US 2026/0076304 A1
(43) Pub. Date: Mar. 19, 2026

(54) ADJUSTABLE COTTON PICKING UNIT PRESSURE DOOR

(71) Applicant: DEERE & COMPANY, MOLINE, IL (US)

(72) Inventors: BRANDON C. CARLSON, ANKENY, IA (US); DANIEL J. JOHANNSEN, DES MOINES, IA (US); ADAM R. EAKER, Ankeny, IA (US); BINGHUI DONG, ANKENY, IA (US); RYAN E. NOBLE, Carlisle, IA (US)

(21) Appl. No.: 19/102,716

(22) PCT Filed: Sep. 1, 2023
(86) PCT No.: PCT/US23/73261

§ 371 Date: Feb. 10, 2025

Related U.S. Application Data
(60) Provisional application No. 63/374,475, filed on Sep. 2, 2022.

(51) Int. Cl. A01D 46/16; A01D 69/03

(52) U.S. Cl. CPC A01D 46/16; A01D 69/03

(57) ABSTRACT

A picking unit for a cotton harvester includes a first rotating picking drum having a first plurality of rotating picker spindles, a first pressure plate mounted on a first hinge and configured to pivot with respect to the first rotating picking drum, a first plurality of torsion springs configured to apply a biasing force on the first pressure plate. Each spring of the first plurality of torsion springs includes a first end connected to the first hinge and a second end in contact with the first pressure plate, and an actuator configured to vary the biasing force applied by the first plurality of torsion springs by rotating the first hinge.

### CROSS-REFERENCE TO RELATED APPLICATIONS

This application claims the benefit of U.S. Provisional Application No. 63/374,475, filed Sep. 2, 2022, the entirety of which is incorporated herein by reference.

### FIELD

The present disclosure relates to cotton picking machines, and in particular to pressure doors for picking units of a cotton picker.

### SUMMARY

A picking unit for a cotton harvester includes a first rotating picking drum having a first plurality of rotating picker spindles, a first pressure plate mounted on a first hinge and configured to pivot with respect to the first rotating picking drum, a first plurality of torsion springs configured to apply a biasing force on the first pressure plate. Each spring of the first plurality of torsion springs includes a first end connected to the first hinge and a second end in contact with the first pressure plate, and an actuator configured to vary the biasing force applied by the first plurality of torsion springs by rotating the first hinge.

In other features, the actuator is a rotary actuator.

In further features, the picking unit includes a shaft and a first gear disposed on the shaft. The picking unit includes a second gear disposed on the first hinge and the first gear is configured to engage the second gear.

In yet further features, the first gear and the second gear are bevel gears.

In other features, at least one of the first gear and the second gear are made of powder metal.

In yet other features, the picking unit includes a frame and a bracket attached to the frame. The bracket includes an opening, the shaft passes through the opening in the bracket, and the first gear is partially disposed within the opening in the bracket.

In further features, the opening in the bracket includes a bearing with an inner surface and an outer surface of the first gear at least partially contacts the inner surface of the bearing.

In other features, the picking unit includes a second rotating picking drum having a second plurality of rotating picker spindles and a second pressure plate mounted on a second hinge and configured to pivot with respect to the second rotating picking drum. The picking unit also includes a second plurality of torsion springs configured to apply a biasing force on the second pressure plate. Each spring of the second plurality of torsion springs includes a first end connected to the second hinge and a second end in contact with the second pressure plate. The actuator is configured to vary the biasing force apply by the second plurality of torsion springs by rotating the second hinge.

In yet other features, the actuator is a linear actuator.

In further features, the picking unit includes a frame and a bracket attached to the frame. The first hinge includes an arm fixedly attached to an end of the first hinge, a first end of the linear actuator is pivotally coupled to the bracket, and a second end of the actuator is pivotally coupled the arm.

In other features, the actuator is a hydraulicly powered actuator.

A cotton picker includes a chassis supported by a plurality of ground engaging members, a power module configured to power at least one of the plurality of ground engaging members, and a plurality of picking units. Each picking unit of the plurality of picking units includes a rotating picking drum having a first plurality of rotating picker spindles, a hinge, a pressure plate mounted on the hinge and configured to pivot with respect to the rotating picking drum, a plurality of torsion springs configured to apply a biasing force on the pressure plate. Each spring of the plurality of torsion springs includes a first end connected to the hinge and a second end in contact with the pressure plate, and an actuator configured to vary the biasing force applied by the plurality of torsion springs by rotating the hinge. The cotton picker also includes a round module builder that includes an accumulator and an air duct system coupleable to the plurality of picking units and the accumulator.

In further features, the actuator is a rotary actuator.

In yet further features, each picking unit of the plurality of picking units includes a shaft, a first gear disposed on the shaft, and a second gear disposed on the hinge and configured to engage the first gear. The first gear is configured to engage the second gear.

In yet further features, the first gear and the second gear are bevel gears.

In other features, at least one of the first gear and the second gear are made of powder metal.

In yet other features, each picking unit of the plurality of picking units includes a frame and a bracket attached to the frame. The bracket includes an opening, the shaft passes through the opening in the bracket, and the first gear is partially disposed within the opening in the bracket.

In other features, the opening in the bracket includes a bearing with an inner surface and an outer surface of the first gear at least partially contacts the inner surface of the bearing.

In yet other features, the actuator is a linear actuator.

In further features, each picking unit of the plurality of picking units includes a frame and a bracket attached to the frame. The hinge includes an arm fixedly attached to an end of the hinge. A first end of the linear actuator is pivotally coupled to the bracket and a second end of the actuator is pivotally coupled the arm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an example agricultural vehicle in the form of a cotton picker vehicle have a plurality of cotton picking units.

FIG. 2 is a side view of the example agricultural vehicle.

FIG. 3 is a perspective view of a first example cotton picking unit that includes adjustable pressure doors according to principles of the present disclosure.

FIG. 4 is a partial top view of the first example cotton picking unit of FIG. 3.

FIG. 5 is a partial perspective view of the adjustable pressure of the fist example cotton picking unit of FIG. 3.

FIG. 6 is another partial perspective view of the adjustable pressure doors of the fist example cotton picking unit of FIG. 3.

FIG. 7 is a perspective view of a second example cotton picking unit that includes adjustable pressure doors according to principles of the present disclosure.

FIG. 8 is a partial perspective view of the second example implementation of adjustable pressure doors of the second example cotton picking unit of FIG. 7.

FIG. 9 is a partial top view of the second example cotton picking unit of FIG. 7.

In the drawings, reference numbers may be reused to identify similar and/or identical elements.

### DETAILED DESCRIPTION

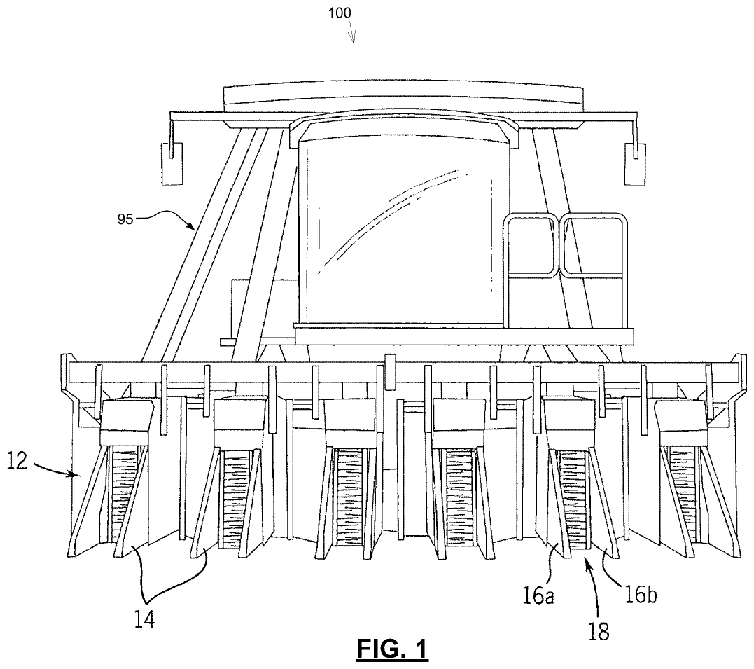

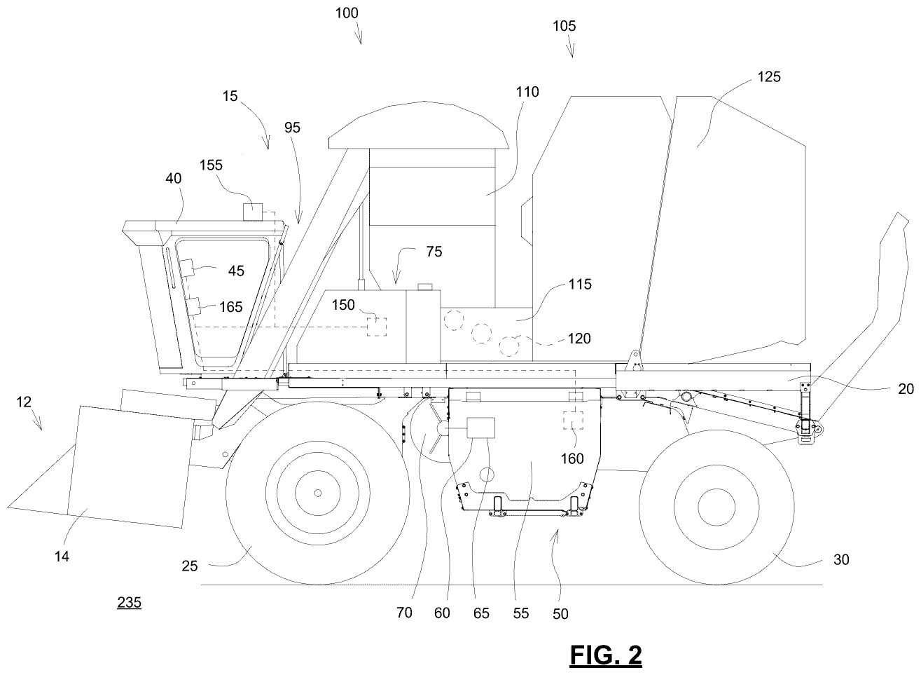

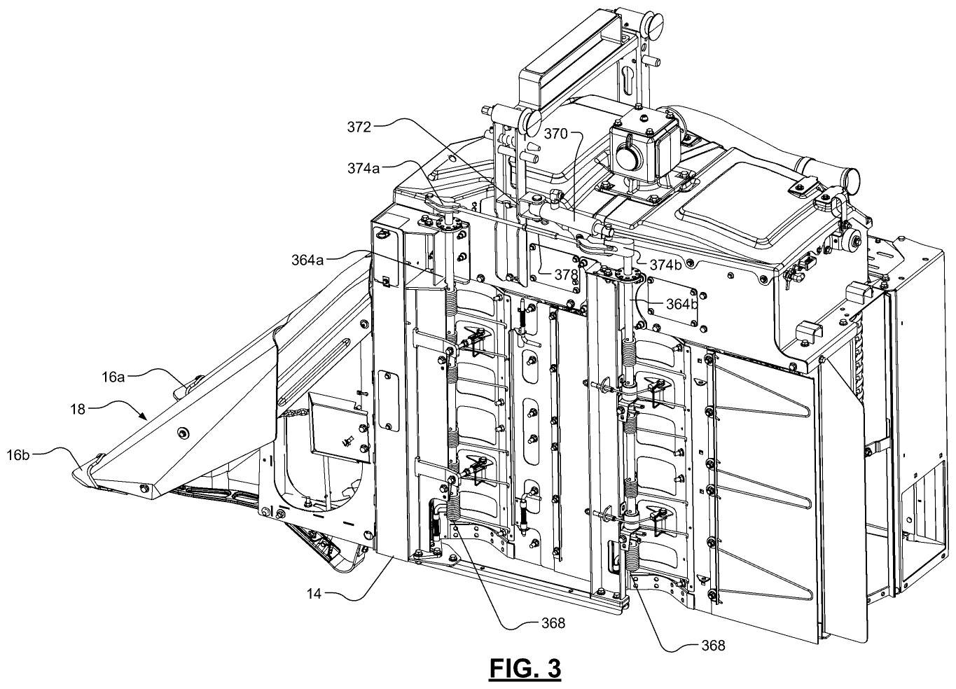

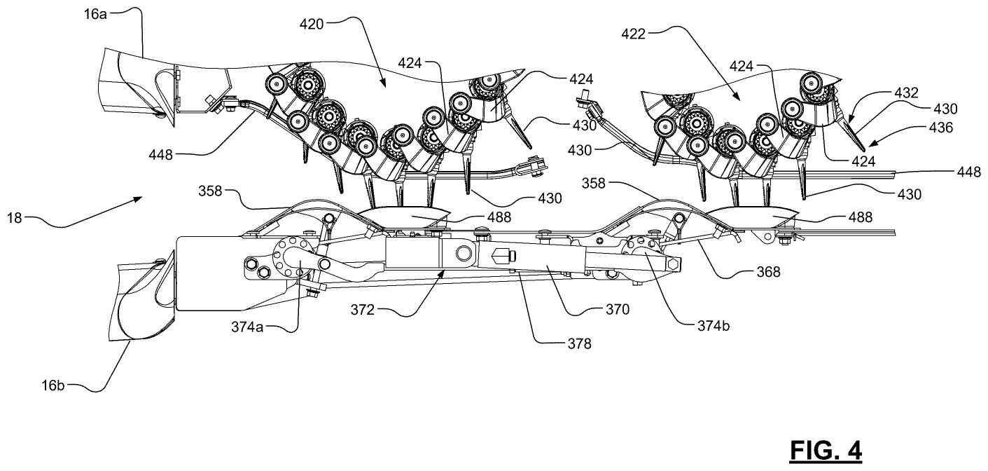

FIGS. 1 and 2 illustrate an example cotton picker 100 having a header unit 12 including a plurality of cotton picking units 14 (e.g., six are shown) arranged side-by-side across the front of the vehicle. Each picking unit 14 may be identical to the other picking unit, so the internal structure for one picking unit will be described below with the understanding that the description also may apply to the other picking units. Each picking unit 14 may include a pair of separators 16a, 16b laterally spaced apart from one another and forming a channel 18 disposed between them. The channels 18 are configured to receive rows of cotton plants as the cotton picker 100 is driven through a field 235 and, as such, the channels 18 are laterally spaced apart from one another substantially the same distance as the rows of the cotton plants to be picked.

The cotton picker 100 includes a chassis 20. The illustrated chassis 20 is supported by front ground engaging members 25 and rear ground engaging members 30. Although the front ground engaging members 25 and rear ground engaging members 30 of the cotton picker 100 are depicted as wheels, other supports are contemplated—for example, tracks. The cotton picker 100 is adapted for movement through the field 235 to perform a task, such as harvesting cotton. An operator station 40 is supported by the chassis 20.

An operator interface 45 is positioned in the operator station 40. In some implementations, the operator interface 45 includes a display screen—for example, a liquid crystal display (LCD), a light emitting diode (LED) screen, an organic LED (OLED) screen, or a CRT display. The display screen of the operator interface 45 may present, via a graphical user interface (GUI), various features and/or parameters of the cotton picker 100. In various implementations, the operator interface 45 may include one or more user input devices—for example, buttons, switches, touch screens, and/or levers. The operator of the cotton picker 100 may adjust various operating parameters of the cotton picker 100 via the operator interface 45—for example, by actuating one or more of the user input devices.

Referring to FIG. 2, a power module 50 may be supported below the chassis 20. The power module may be an engine 55 that drives a hydraulic motor 60 or a mechanical drive 65 to power a variable pitch fan 70 and at least one of the front ground engaging members 25 and the rear ground engaging members 30. An operator may set a minimum power for the power module 50 from the operator interface 45. The operator may also set a minimum engine speed from the operator interface 45. Water, lubricant, and fuel tanks, indicated generally at 75, may be supported on the chassis 20.

A With reference to FIGS. 1 and 2, an air duct system 95 is coupleable to the header 12. A round module builder 105 is coupleable to the air duct system 95. The round module builder 105 includes an accumulator 110 that is configured to receive cotton, or other crop, harvested by the cotton picking units 14. With continued reference to FIG. 2, a feeder 115 is coupleable to the chassis 20. The feeder 115 is configured to receive cotton, from the accumulator 110. The feeder 115 includes a plurality of rollers 120 configured to compress the cotton and transfer the cotton to a baler 125 of the round module builder 105.

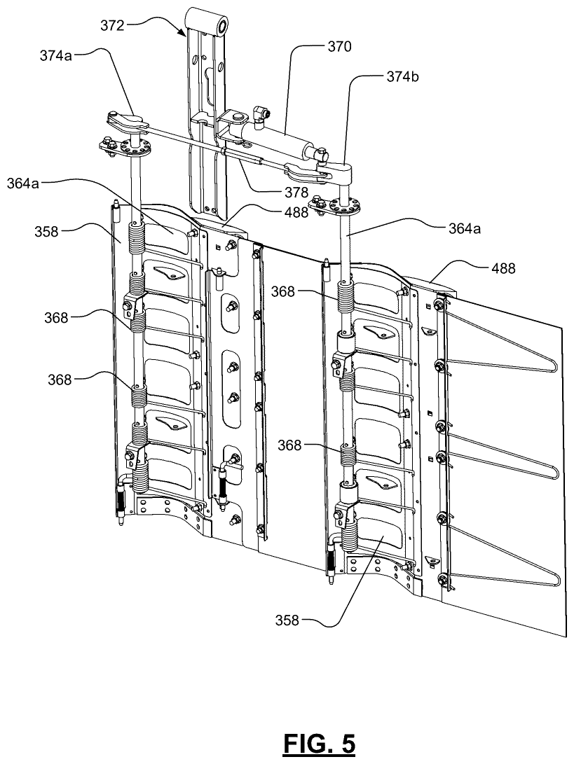

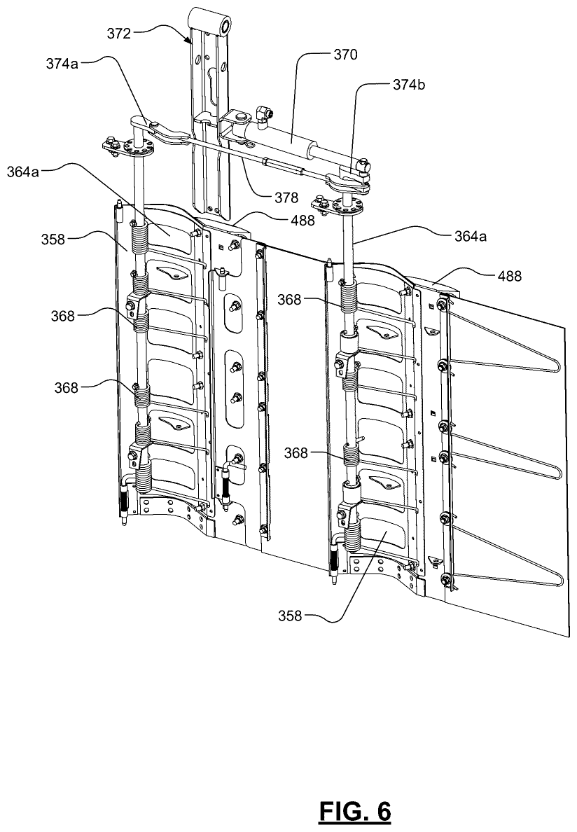

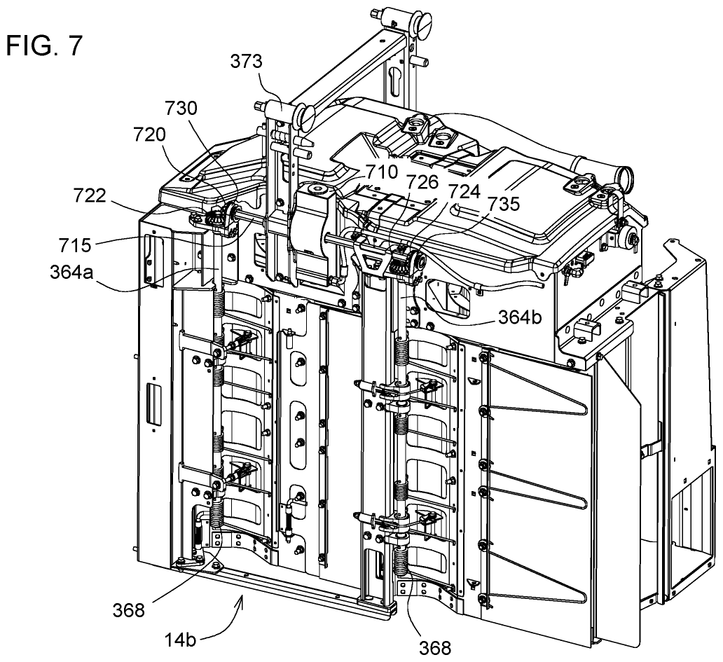

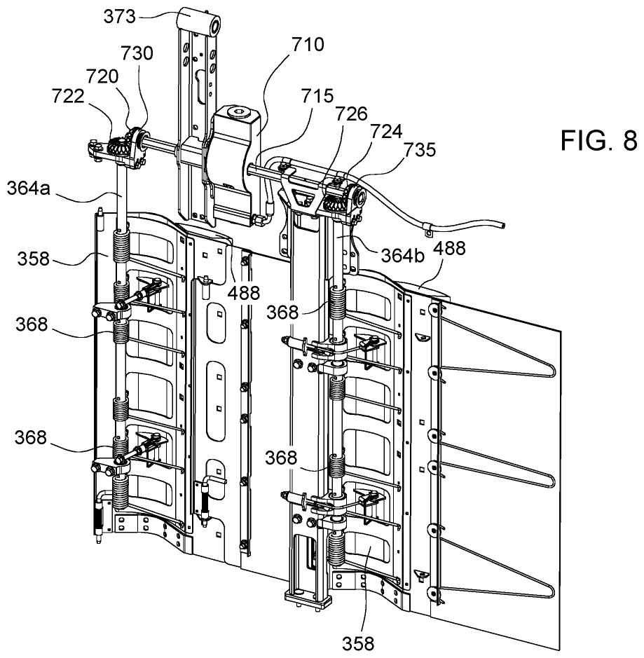

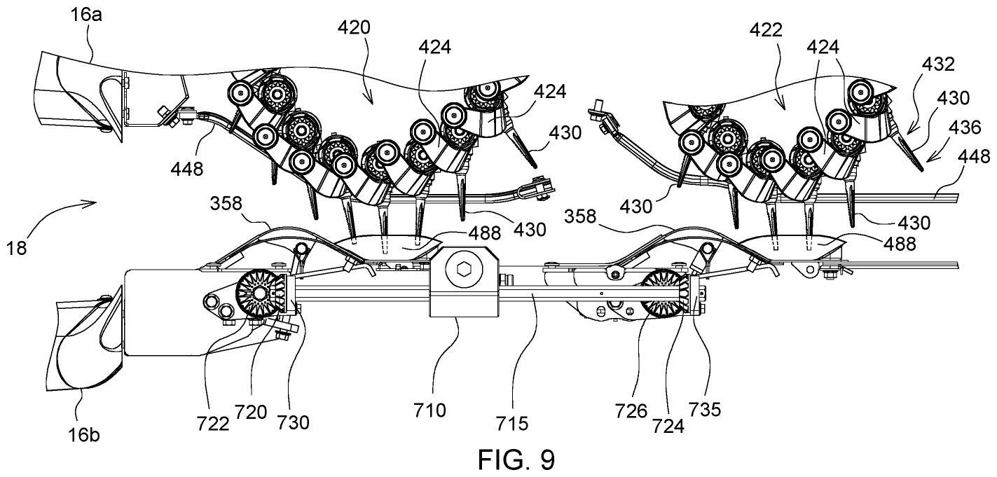

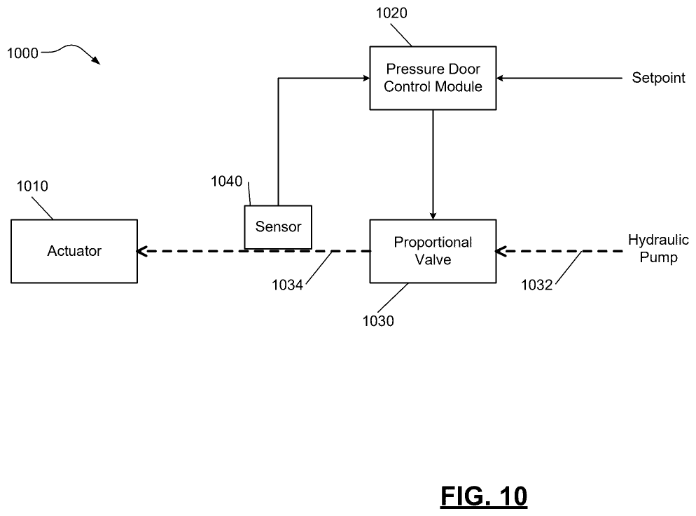

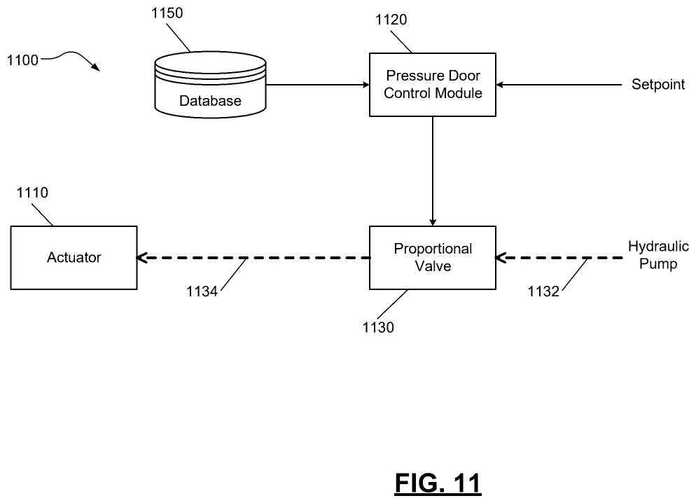

FIG. 4-6 depict a first example picking unit 14a, while FIG. 7-9 depict a second example picking unit 14b. The first example picking unit 14a and the second example picking unit 14b represent two example implementations of the picking unit 14 according to the principles of the present disclosure. Referring to FIGS. 4 and 9, each picking unit 14 may include a front (or first) picking drum 420 and a rear (or second) picking drum 422 disposed along one side of the channel 18. The picking drums 420, 422 may each include a plurality of picker bars 424 disposed around the circumferences of the picking drums 420, 422. The picking drums 420, 422 may be vertically aligned about parallel axes (drum axes) and the picker bars 424 may be disposed in parallel to each other and the drum axes. Each picker bar 424 may be operably coupled to the associated drum 420, 422 at its top end and its bottom end to be pivotal about a picker bar axes, which are parallel to the drum axes.

A plurality of picker spindles 430 are disposed on each picker bar 424 with a proximal end 432 of the spindle 430 being located next to the picker bar 424. Each spindle 430 may have a conical body tapering to a distal end 436 and including one or more serrated barbs. In the illustrated implementations, the spindles 430 are disposed substantially perpendicular to the picker bar 424 on which they are mounted, collectively in an array of columns and rows, and they may be configured to rotate about an axis extending through the proximal 432 and distal 436 ends. The spindles 430 may be disposed at other non-perpendicular acute or obtuse angles relative to the picker bar 424 on which they are mounted.

The rear drum 422 may be the same or similar to the front picking drum 420. For example, the front 420 and rear 422 drums may include the same number of picker bars 424 and spindles 430 per picker bar 424. However, the rear picking drum 422 may include a different number of picker bars 424 and/or a different number of spindles 430 per picker bar 424. In some implementations, the rear picking drum 422 may include fewer picker bars 424 (e.g., twelve) than the front picking drum 420 (e.g., sixteen) and the same number of spindles 430 per picker bar 424 (e.g., twenty) . Additionally, the front 420 and rear 422 drums may be configured to rotate at generally the same speed or at different speeds. In some implementations, the front picking drum 420 has a larger diameter than the rear picking drum 422, and the front picking drum 420 may rotate between about 140-150 r.p.m., and the rear drum 422 may rotate between about 160-170 r.p.m. The spindles 430 may be rotated at a constant, such as about 4,500 r.p.m, or at a varied speed.

Referring to FIGS. 4 and 9, each picking unit 14 also may include a series or array of grid bars 448 for each drum 420, 422, which may be disposed between vertically adjacent pairs of spindles 430. The grid bar array 448 may serve to keep plant material from passing through the channel 18 away from the picking drums 420, 422, while at the same time positioning the plant material so that the spindles 430 may interact more effectively with the plants to remove the cotton from the bolls. Thus, the grid bar arrays 448 may be located proximate the proximal ends 432 of the spindles 430 so that a majority of each spindle 430, including the serrated distal end 436, protrudes into the channel 18 beyond the grid bar arrays 448. The grid bars themselves may be aligned in a column, thereby forming rows of channels between adjacent pairs of grid bars. Each spindle 430 may be configured to pass through a respective channel, such that one or both of each grid bar array 448 and the channels may be disposed substantially perpendicular to the picker bars 424, or may otherwise create a path to the spindles 430 even if not substantially perpendicular to the picker bars 424. Each grid bar array 448 may have a leading segment and a trailing segment, and the leading segment may be configured to contour around a portion of a circumference of the picking drums 420, 422. Specifically, the leading segment may be linear or curvilinear and may extend, e.g., between about ⅛ and about ¼ of the way around a circumference of each drum 420, 422. The trailing segment may be disposed generally in line with a direction of the channel 18. (For example, the line may be a line tangent to the drum 420, 422 at a location where a radius of the drum 420, 422 is perpendicular to the direction of the channel 18. A transition between the leading segment and the trailing segment may be at a location upstream from that tangent position.)

On the opposite side of the channel 18 as the picking drums 420, 422, the picking unit 14 may include pressure plates 358, one for each drum 420, 422, which is configured to press the plant material passing through the channel 18 toward the picking drums 420, 422. Each pressure plate 358 may have a front (channel-and drum-facing) side and a rear side. Each pressure plate 358 may also include or interface with a stop to limit the degree to which the plate is capable of traveling into the channel 18, for example, as described in detail below. The stop may be a mechanical structure physically preventing further movement of the pressure plate 358, or it may be a programmed limit position (e.g., in the case where movement of the pressure plates 358 is electronically controlled).

One or more torsion springs 368 may be disposed around a hinge 364. Each torsion spring 368 may have a spring end that applies a force on the rear side of the pressure plate 358 to bias the pressure plate 358 toward the channel 18. Each torsion spring 368 may also have a fixed end connected to the hinge. There may be at least one, and likely multiple, torsion springs 368 disposed along each hinge 364 to apply forces along the length of the pressure plate 358.

Each pressure plate 358 may include a first segment extending rearward and inward (i.e., into and narrowing the channel 18, when viewed from the top) from the leading end, which may assist in funneling plant material into the channel 18. A second segment may extend generally parallel to the direction of the channel 18, followed by third and fourth segments that, like the grid bar arrays 448, may be configured to contour around a portion of the circumference of the picking drums 420, 422. Thus, the third segment may extend rearward and outward from the second segment, and the fourth segment may extend generally parallel to the direction of the channel 18 (i.e., in a plane generally parallel to the plane tangent to the drum 420, 422 at that location). The fourth segment may be located rearward into the channel 18 at a location that overlaps with the trailing segment of the associated grid bar array 448, although the fourth segment may be significantly shorter than the trailing segment. Further following the path of the picking drums 420, 422, the pressure plates 358 may each include a fifth segment extending rearward and inward from the fourth segment, a sixth segment extending rearward and outward, and a seventh segment extending generally parallel to the direction of the channel 18. Each of these segments may be generally planar surfaces, although they may also be various concave, convex, angled, or other irregularly shaped surfaces. In addition, it will be understood that these directions refer to the pressure plates 358 as oriented in their configuration biased toward the picking drums 420, 422, and that they will change if the pressure plates 358 are hinged outward (e.g., due to plant material passing through the channel 18 and forcing the pressure plates 358 outward). The pressure plates 358 themselves may be substantially rigid such that the relative angles between pressure plate segments may not change when the pressure plates 358 are rotated outward. Further, the third and fourth segments may form an obtuse angle with respect to one another, and the fourth and fifth segments may form an obtuse angle with respect to one another. These two angles may differ, or as illustrated, they may be substantially the same such that the third, fourth, and fifth segments combine to form a trough having a flat bottom spaced away from the associated drum 420, 422 with angled sides that project toward the drum 420, 422. As the picking drums 420, 422 turn, the picker bars 424 rotate with the picking drums 420, 422 and also about their axes, causing columns of spindles 430 to enter the trough, moving toward the third segment, along the fourth segment, and away from the fifth segment as they exit the trough.

Each pressure plate 358 may include one, and more likely a plurality, of scrapping plates 488 for each drum 420, 422. The scrapping plates 488 may be formed as a single piece with the pressure plate 358 or, alternatively, they may be separate elements coupled to the pressure plate 358, which may facilitate repair or replacement of the scrapping plates 488 in the event they become damaged or broken. Each scrapping plate 488 may be formed of a rigid, but non-brittle material that resists both deformation and fracture during use. In one implementation, the scrapping plates 488 may be made of a metal, such as steel or aluminum. The scrapping plates 488 may be formed as a unitary part, for example, using a casting process or bending or machining techniques. Alternatively, the scrapping plates 488 may be fabricated from multiple pieces of metal, such by welding. Each scrapping plate 488 may be formed separately. Alternatively, a plurality of scrapping plates 488 may be formed as a single unit.

With reference to FIG. 4-6, the first example picking unit 14a includes a linear actuator 370 that includes a first end pivotally coupled to a bracket 372 on frame 373 of the picking unit 14a. As illustrated, the linear actuator 370 may be a hydraulic cylinder. In other implementations, the linear actuator 370 may be electrically or pneumatically driven. In some implementations, the linear actuator 370 is single acting—i.e., capable of applying force in a single direction. In other implementations, the linear actuator 370 is double acting—i.e., capable of applying force in two opposing directions.

Each hinge 364a, 364b includes an arm 374a, 374b, respectively, fixedly attached to an end of the hinge 364a, 364b. A second end of the linear actuator 370 is pivotally coupled to the arm 374b of hinge 364b. The arm 374a is coupled to arm 374b via linkage 378. In some implementations, the linkage 378 is an adjustable length linkage, as illustrated. In other implementations, linkage 378 is a fixed length.

Actuation of the linear actuator 370 results in the rotation of hinges 364a, 364b. Rotation of hinges 364a, 364b causes the biasing force exerted by springs 368 on pressure plates 358 to increase or decrease. For example, when the linear actuator 370 extends, hinges 364a, 364b, rotate in a counter-clockwise direction, with respect to the orientation of FIG. 4, and the force exerted by the springs 368 on the pressure plates 358 increases. Alternatively, when the linear actuator 370 retracts, hinges 364a, 364b, rotate in a clockwise direction, with respect to the orientation of FIG. 4, and the force exerted by the springs 368 on the pressure plates 358 decreases.

In some implementations, the linear actuator 370 of the first example picking unit 14a may be independently operated—for example, via the operator interface 45 in the operator station 40. In other implementations, the linear actuators 370 of two or more picking units are linked and are actuated—i.e., extended or retracted—in unison.

With reference to FIG. 7-9, the second example picking unit 14b includes a rotary actuator 710 and a shaft 715. The rotary actuator 710 is configured to act on the shaft 715—e. g, rotate the shaft 715. In some implementations, the rotary actuator 710 is a hydraulicly actuator. In other implementations, the rotary actuator 710 may be an electric actuator, a pneumatic actuator, or another suitable actuator able to rotate the shaft 715. In various implementations, the rotary actuator 710 is a single acting rotary actuator. In other implementations, the rotary actuator 710 is a double acting rotary actuator.

The shaft 715 includes a first gear 720 that engages a first hinge gear 722 connected to the hinge 364a and a second gear 724 that engages a second hinge gear 726 connected to the hinge 364b, such that rotation of the shaft 715—e.g., by the rotary actuator 710—results in the rotation of hinges 364a, 364b. Rotation of hinges 364a, 364b causes the biasing force exerted by springs 368 on pressure plates 358 to increase or decrease. For example, in response to the rotary actuator 710 rotating the shaft 715 in a first direction, hinges 364a, 364b, rotate in a counter-clockwise direction, with respect to the orientation of FIG. 9, and the force exerted by the springs 368 on the pressure plates 358 increases. Alternatively, in response to the rotary actuator 710 rotating the shaft 715 in a second direction, hinges 364a, 364b, rotate in a clockwise direction, with respect to the orientation of FIG. 9, and the force exerted by the springs 368 on the pressure plates 358 decreases.

In various implementations, the first gear 720 and the second gear 724 are made of powder metal. In other implementations, the first fear 720 and the second gear 724 are made of a heat treated metal—for example, steel. In various implementations, the first gear 720, the first hinge gear 722, the second gear 724, and the second hinge gear 726 are bevel gears.

The shaft 715 passes through an opening in a first shaft bracket 730 and an opening in a second shaft bracket 735. A portion of the first gear 720 is disposed inside of the opening on the first shaft bracket 730. A portion of the second gear 724 is disposed inside of the opening in the second shaft bracket 735. In some implementations, the opening in the first shaft bracket 730 and the opening in the second shaft bracket 735 each include a bushing. An outer surface of the portion of the first gear 720 disposed inside of the opening in the first shaft bracket 730 rides on an inner surface of the bearing of the first shaft bracket 730. Similarly, an outer surface of the portion of the second gear 724 disposed inside of the opening in the second shaft bracket 735 rides on an inner surface of the bearing of the second shaft bracket 735.

In some implementations, the rotary actuator 710 of the second example picking unit 14b may be independently operated—for example, via the operator interface 45 in the operator station 40. In other implementations, the rotary actuators 710 of two or more picking units 14 are linked and are actuated—i.e., rotated—in unison. In yet other implementations (not shown), the hinge 364a and the hinge 364b are connected to independent rotary actuators.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A picking unit for a cotton harvester comprising:
a first rotating picking drum having a first plurality of rotating picker spindles;
a first pressure plate mounted on a first hinge and configured to pivot with respect to the first rotating picking drum;
a first plurality of torsion springs configured to apply a biasing force on the first pressure plate, wherein each spring of the first plurality of torsion springs includes a first end connected to the first hinge and a second end in contact with the first pressure plate; and
an actuator configured to vary the biasing force applied by the first plurality of torsion springs by rotating the first hinge.

2. The picking unit of claim 1, wherein the actuator is a rotary actuator.

3. The picking unit of claim 2, further comprising:
a shaft;
a first gear disposed on the shaft; and
a second gear disposed on the first hinge,
wherein the first gear is configured to engage the second gear.

4. The picking unit of claim 3, wherein the first gear and the second gear are bevel gears.

5. The picking unit of claim 3, wherein at least one of the first gear and the second gear are made of powder metal.

6. The picking unit of claim 3, further comprising:
a frame; and
a bracket attached to the frame,
wherein the bracket includes an opening, the shaft passes through the opening in the bracket, and the first gear is partially disposed within the opening in the bracket.

7. The picking unit of claim 6, wherein the opening in the bracket includes a bearing with an inner surface and wherein an outer surface of the first gear at least partially contacts the inner surface of the bearing.

8. The picking unit of claim 1, further comprising:
a second rotating picking drum having a second plurality of rotating picker spindles;
a second pressure plate mounted on a second hinge and configured to pivot with respect to the second rotating picking drum; and
a second plurality of torsion springs configured to apply a biasing force on the second pressure plate, wherein each spring of the second plurality of torsion springs includes a first end connected to the second hinge and a second end in contact with the second pressure plate,
wherein the actuator is configured to vary the biasing force apply by the second plurality of torsion springs by rotating the second hinge.

9. The picking unit of claim 1, wherein the actuator is a linear actuator.

10. The picking unit of claim 9, further comprising:
a frame; and
a bracket attached to the frame,
wherein:
the first hinge includes an arm fixedly attached to an end of the first hinge,
a first end of the linear actuator is pivotally coupled to the bracket, and
a second end of the actuator is pivotally coupled the arm.

11. The picking unit of claim 1, wherein the actuator is a hydraulicly powered actuator.

12. A cotton picker comprising:
a chassis supported by a plurality of ground engaging members;
a power module configured to power at least one of the plurality of ground engaging members;
a plurality of picking units, wherein each picking unit of the plurality of picking units includes:
a rotating picking drum having a first plurality of rotating picker spindles;
a hinge;
a pressure plate mounted on the hinge and configured to pivot with respect to the rotating picking drum;
a plurality of torsion springs configured to apply a biasing force on the pressure plate, wherein each spring of the plurality of torsion springs includes a first end connected to the hinge and a second end in contact with the pressure plate; and
an actuator configured to vary the biasing force applied by the plurality of torsion springs by rotating the hinge;
a round module builder that includes an accumulator; and
an air duct system coupleable to the plurality of picking units and the accumulator.

13. The cotton picker of claim 12, wherein the actuator is a rotary actuator.

14. The cotton picker of claim 13, wherein each picking unit of the plurality of picking units includes:
a shaft;
a first gear disposed on the shaft; and
a second gear disposed on the hinge and configured to engage the first gear,
wherein the first gear is configured to engage the second gear.

15. The cotton picker of claim 14, wherein the first gear and the second gear are bevel gears.

16. The cotton picker of claim 14, wherein at least one of the first gear and the second gear are made of powder metal.

17. The cotton picker of claim 14, wherein each picking unit of the plurality of picking units includes:
a frame; and
a bracket attached to the frame,
wherein the bracket includes an opening, the shaft passes through the opening in the bracket, and the first gear is partially disposed within the opening in the bracket.

18. The cotton picker of claim 14, wherein the opening in the bracket includes a bearing with an inner surface and wherein an outer surface of the first gear at least partially contacts the inner surface of the bearing.

19. The cotton picker of claim 12, wherein the actuator is a linear actuator.

20. The cotton picker of claim 19, wherein:
each picking unit of the plurality of picking units includes:
a frame; and
a bracket attached to the frame;
the hinge includes an arm fixedly attached to an end of the hinge;
a first end of the linear actuator is pivotally coupled to the bracket; and
a second end of the actuator is pivotally coupled the arm.
